(19) United States
(12) Patent Application Publication
(10) Pub. No.: US 2015/0233152 A1
(43) Pub. Date: Aug. 20, 2015

(54) LATCH HOUSING WITH INTEGRAL ATTACHMENT FEATURE

(71) Applicants: Francisco Vazquez, Chihuahua (MX); Eduardo Estrada, Chihuahua (MX); Alfredo Martinez, Chihuahua (MX); Manuel Escamilla, Chihuahua (MX)

(72) Inventors: Francisco Vazquez, Chihuahua (MX); Eduardo Estrada, Chihuahua (MX); Alfredo Martinez, Chihuahua (MX); Manuel Escamilla, Chihuahua (MX)

(21) Appl. No.: 14/623,380

(22) Filed: Feb. 16, 2015

Related U.S. Application Data
(60) Provisional application No. 61/940,189, filed on Feb. 14, 2014.

(51) Int. Cl. E05B 85/02

(52) U.S. Cl. CPC E05B 85/02

(57) ABSTRACT

A latch, having: an actuator housing configured to be “snap fit” or coupled to a latch housing of the latch.

### CROSS REFERENCE TO RELATED APPLICATIONS

This application claims the benefit of U.S. Provisional Patent Application Ser. No. 61/940,189, filed Feb. 14, 2014, the contents of which are incorporated herein by reference thereto.

### BACKGROUND

Various embodiments of the present invention relate to a latch and more particularly, a vehicle latch.

In some applications, latches are required to perform numerous operations within limited confines of an application area of the item they are installed in.

Accordingly, it is desirable to provide a latch with a latch housing that is able to perform the required functions while being subject to certain space requirements.

### SUMMARY OF THE INVENTION

A latch, having: an actuator housing configured to be “snap fit” or coupled to a latch housing of the latch.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a view of a latch and associated housings according to various embodiments of the present invention; and

FIG. 2 is a view of an opposite side of the housings illustrated in FIG. 1.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Reference is made to the following U.S. Pat. Nos. 3,969,789; 6,568,741; 6,679,531; 8,348,310 and U.S. Patent Publication Nos. US 2010/0127512; US 2011/0204659; US 2012/0292927 and provisional Patent Application Ser. No. 61/806,530 filed Mar. 29, 2013, the entire contents each of which are incorporated herein by reference thereto.

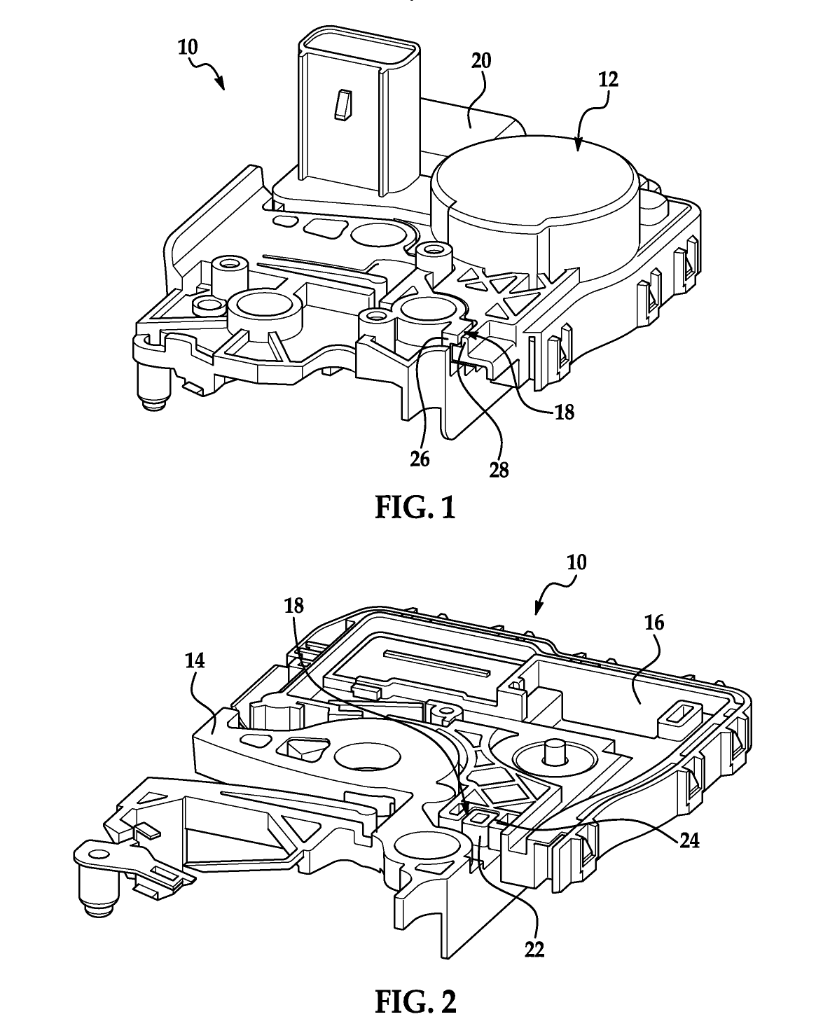

Referring now to the FIGS. and in particular, FIGS. 1-2, a latch 10 is illustrated. In one embodiment, the latch 10 is a vehicle door latch or any other type of vehicle latch. Latch 10 has an actuator 12 operatively coupled to components of the latch 10 that are located within a latch housing 14. The actuator 12 has an actuator housing 16 that is configured to be “snap fit” or coupled to the latch housing 14.

As illustrated, the latch will have an integral actuator 12 that utilizes a worm and worm gear solution for a lock/unlock actuator. In order to secure the actuator housing 16 to the latch housing 14 integral securement features 18 are provided. The integral securement features 18 are molded into the housings 14 and 16, which are formed out an easily molded material such as plastic. Alternatively, the securement features may be insert molded into the housings 14 and 16.

As illustrated, the integrally formed securement features 18 provide snap fit reaction surfaces that will maintain the actuator housing 16 in the correct position with respect to housing 14 as the actuator 12 of the latch 10 is operated.

The illustrated features 18 allows the actuator housing 12 and its associated cover 20 to maintain its relative position to the latch housing 14 without increasing the cost of the part. The snap fit feature 18 is modeled in an area of the housings that does not require the use of a sliding feature to create the connection and securement of the housings to each other.

As illustrated, a holding feature 22 is received within an area 24 of actuator housing 16 and a feature 26 of housing 14 engages a complimentary feature 28 of the cover 20 when the housings of the latch are assembled.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch, comprising:
an actuator housing configured to be “snap fit” or coupled to a latch housing of the latch.

2. The latch as in claim 1, wherein actuator housing and the latch housing each have complimentary integrally formed attachment features.

3. The latch as in claim 2, actuator housing and the latch housing are formed from plastic.

4. The latch as in claim 1, wherein the actuator housing has an area to receive a holding feature of the housing when the housing is secured to the actuator housing.

5. The latch as in claim 4, wherein the actuator housing has a feature that engages a complimentary feature of the housing when the housing is secured to the actuator housing.

6. The latch as in claim 5, wherein the holding feature is located on an opposite side of the housing with respect to the complimentary feature of the housing.

7. The latch as in claim 5, wherein the latch is a vehicle door latch.

8. The latch as in claim 5, wherein the actuator housing is configured to house a lock/unlock actuator of the latch.

9. The latch as in claim 8, wherein the holding feature is located on an opposite side of the housing with respect to the complimentary feature of the housing.

10. The latch as in claim 9, wherein the features of the actuator housing and the latch housing are integrally formed with the actuator housing and the latch housing.

11. The latch as in claim 10, actuator housing and the latch housing are formed from plastic.
